(19) United States
(12) Patent Application Publication
(10) Pub. No.: US 2005/0183328 A1
(43) Pub. Date: Aug. 25, 2005

(54) Support system

(76) Inventor: Thomas Robert Corbett, Herefordshire (GB)

Correspondence Address: JOEL D. SKINNER, JR.;SKINNER AND ASSOCIATES, 212 COMMERCIAL ST., HUDSON, WI, 54016, US

(21) Appl. No.: 10/514,270

(22) PCT Filed: Apr. 28, 2003
(86) PCT No.: PCT/GB03/01806

(30) Foreign Application Priority Data
May 2, 2002 (GB) 0210091.5

(51) Int. Cl. A01G 13/02

(52) U.S. Cl. 47/20.1

(57) ABSTRACT

A support system includes an end frame comprising a pair of uprights (20), and a cross member (22), each upright (20) being secured at its lower end to a base member (26), a diagonal strut (28) interconnecting the base member (26) and the upright (20).

This invention relates to a support system suitable for use in the cultivation of crops. In particular the invention relates to a support system for a poly tunnel providing increased strength and permitting the automated operation of handling and other equipment for use in or with the tunnel. However, it will be appreciated that the support system may be used in other applications, for example in supporting the crops.

Poly tunnels are in widespread use in the United Kingdom in the cultivation of for example, soft fruits. A poly tunnel typically comprises, in its simplest form, a plurality of generally inverted U-shaped hoops over which a covering is located. The hoops are typically located on ‘legs’ that are anchored in place by screwing them into the soil. However, alternative techniques may be used, for example if the poly tunnel is to be erected upon a hard standing.

The benefits of poly tunnels are that they protect crops from rain and other adverse weather conditions, extend the growing season, provide a controllable growing environment and reduce wastage.

In spite of these advantages, however, the limited strength of the basic design of existing tunnels prevents their use in windy conditions reducing the length of the season over which they can be used. The nature of the crops cultivated in poly tunnels tends to be very high value and very labour intensive and therefore by improving the environmental control inside the poly tunnel and using the strength of the poly tunnel to partially mechanise operation currently done manually the user will be able to reduce production costs.

Although not restricted to use with a poly tunnel of such simple form, one aspect of the invention relates to a support system incorporating an end frame for use with a poly tunnel. According to the present invention there is provided a support system including an end frame comprising a pair of uprights and a cross member, each upright being secured at its lower end to a base member which extends, in use, in a direction generally parallel to the longitudinal axis of the poly tunnel, and a diagonal strut interconnecting the base member and associated upright. Such an arrangement is advantageous in that it provides good strength to the end of the support frame. A poly tunnel incorporating the system thus has an improved ability to withstand adverse weather conditions. Similar advantages may arise where the support system is used in other applications.

The invention also relates to a system that includes a plurality of end frames located side-by-side with a drive shaft extending along the cross member of each of the end frames, the drive shafts being connected to one another such that a single power source can be used to drive all of the drive shafts. The drive shafts may be used to drive equipment to assist in environmental control and facilitate the partial mechanisation of operations associated with crops being grown. The frame further conveniently includes a plurality of power take-off points whereby machinery associated with the poly tunnel can be driven from the drive shaft. The machinery may include, for example, harvesting rigs, devices for operating vents, moving screens, or lifting doors, or a number of other operations.

The invention further relates to an arrangement in which a plurality of support systems are located side-by-side, a drive shaft being associated with each support system, the drive shafts being interconnected such that a single motor can be used to drive all of the drive shafts.

As mentioned hereinbefore, the support systems may be used in the support of poly tunnels, but may alternatively be used in other applications, for example in the support of agricultural crops.

The invention will further be described, by way of example, with reference to the accompanying drawings, in which:

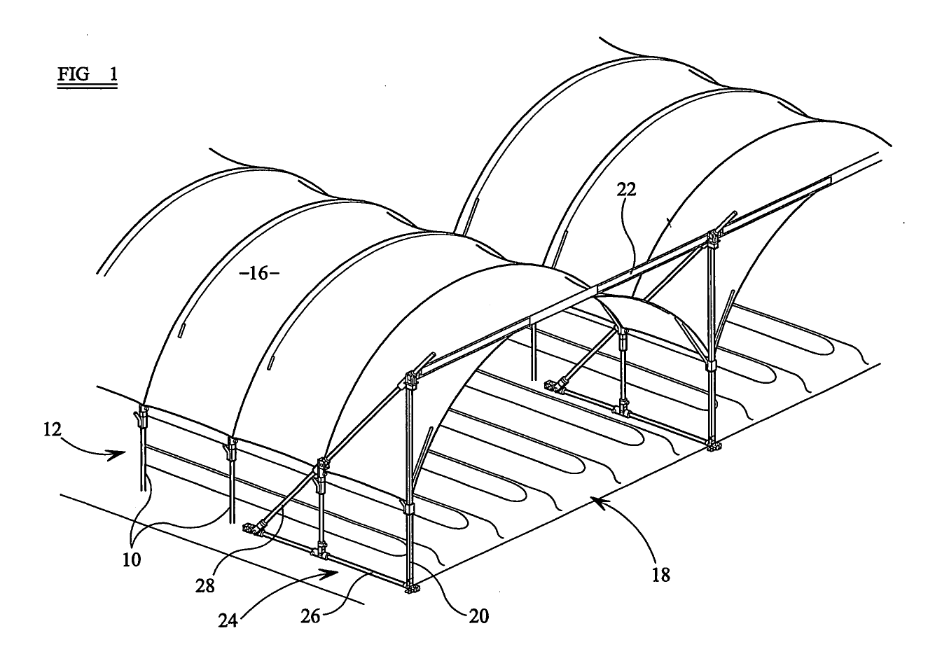

FIG. 1 is a diagrammatic perspective view of part of a poly tunnel arrangement incorporating a support system in accordance with an embodiment of the invention;

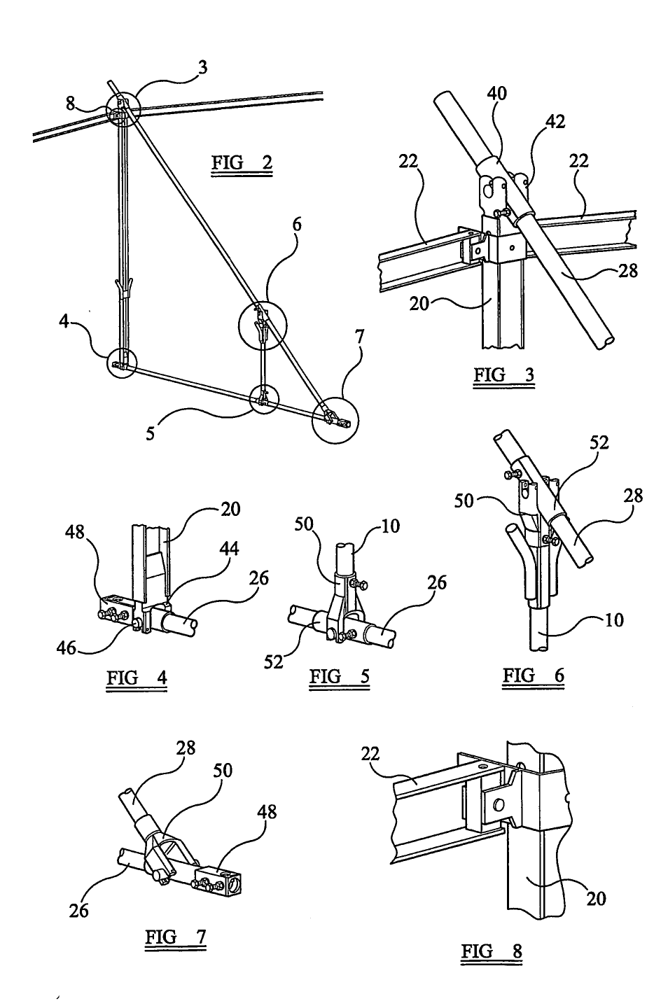

FIG. 2 is a view of part of one of the end frames of the poly tunnel of FIG. 1;

FIGS. 3 to 8 are enlarged views showing various parts of the end frame;

FIG. 9 is a diagrammatic view showing the position of some power take-off points; and

FIGS. 10 to 14 are views showing an alternative embodiment.

The poly tunnels illustrated in FIG. 1 each comprise a support system including a plurality of upright legs 10 arranged in rows 12. Interconnecting hoops 14 are located between pairs of legs 10. A sheet 16 is stretched over the support system to form a tunnel. FIG. 1 illustrates parts of two adjacent tunnels. In order to improve the rigidity of the tunnel structures, in accordance with the invention, at each open end of each tunnel the support system includes a tunnel end frame 18.

Each end frame 18 comprises a pair of triangular frames 24 (shown in more detail in FIG. 2) which are secured to a cross member 22. The uprights 20 of the triangular frame 24 are supported by a base member 26 and a diagonal strut 28 which interconnects the base member 26 and the upright 20.

The support system further replaces the last two legs 10 at the end of each tunnel with two integrated legs. The first of these legs is fixed to the upright 20 and supports the end of one of the hoops 14. The second of these legs is secured, at its lower end, to the base member 26, and at its upper end to the diagonal strut 28. It will be appreciated, therefore, that these two legs are held particularly rigidly in an upright condition. It will be appreciated, therefore, that the end two of the hoops 14 are both supported in a relatively rigid manner as compared to the remainder of the hoops 14 as the supports for the end two of the hoops form part of the triangular support frame for the end frame 18.

In order to allow for variances in dimensions, uneven or sloping ground surfaces or situations where the ends of the poly tunnels are not perpendicular to the crop rows, each joint of the end frame uses connectors in such a manner as to allow some adjustment of all the members relative to the upright in two perpendicular directions, during construction. The nature of the connections between the various components of the side frames 24 are shown in greater detail in FIGS. 3 to 8.

FIG. 3 illustrates the connection between the upper part of one of the uprights 20 and the diagonal strut 28. As illustrated, this connection includes a sleeve 40 which extends around a part of the strut 28 and is securable to the strut 28 to prevent movement of the sleeve along the strut 28. A housing member 42 is pivotally secured to the sleeve 40, the housing member 42 being secured to the upper part of the upright 20 and carrying brackets for use in securing the cross member 22, the drive shaft 30 (see below) and the auxiliary drive shaft 36 (see below) in position. The design of the housing member 42 is such as to permit the desired movement during assembly.

FIG. 4 illustrates the connection between the lower part of the upright 20 and the base member 26. This connection simply takes the form of a bracket 44 mounted upon the lower part of the upright 20 and secured to a pin 46 secured to the base member 26. Also secured to the base member 26 is a housing 48 whereby a soil anchor may be used to secure the base member 26 in position, in use.

FIG. 5 illustrates a connection between the lower part of the support 10 and the base member 26. This connection takes the form of a bracket 50 secured to the lower end of the support member 20, the bracket 50 being secured to a sleeve 52 which in turn is secured to the base member 26.

FIG. 6 illustrates the connection between the upper part of the support member 10 and the strut 28. This connection is very similar to that illustrated in FIG. 5. Like reference numerals are used to denote like parts.

FIG. 7 illustrates the connection between the base member 26 and the strut 28. Again, this arrangement is similar to that shown in FIG. 5. Again, a housing 48 is provided whereby a soil anchor may be used to secure the base member 26 in position, in use.

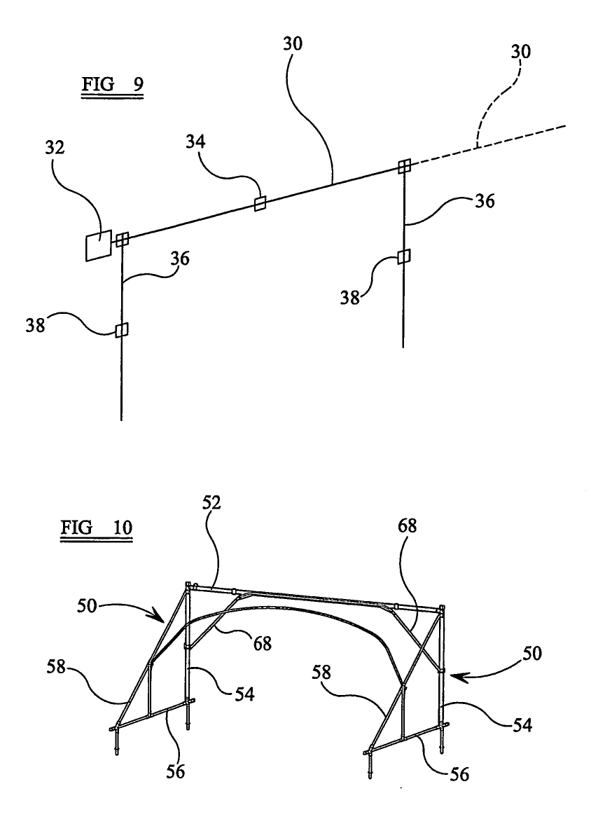

FIG. 8 illustrates the joint between the support member 20 and the cross member 22. As illustrated, this joint allows the cross member 22 to articulate in two generally perpendicular axes while keeping the front face of the cross member 20 in the generally same vertical plane as the front face of the support member 20.

In addition to serving to provide additional rigidity to the end of the poly tunnel the end frame 18 further serves to support a drive shaft 30 which extends along and is supported by the cross member 22. As illustrated diagrammatically in FIG. 9, the drive shaft 30 is driven by a motor 32 for rotation about its axis. Where, as illustrated, two or more poly tunnels are located adjacent one another, then the drive shaft 30 of one of the tunnels may be connected to the drive shaft of an adjacent one of the tunnels, thus all of the drive shafts for the series of tunnels may be driven by a single power source. A number of power take off points are provided whereby machinery associated with the poly tunnels may be arranged to be driven by the drive shaft 30. Some suitable locations for the power take off points are illustrated in FIG. 9. These positions include a position denoted by reference numeral 34 in FIG. 9 at the mid-point of the cross member 22.

By way of example only, this power take off point may be used to drive machinery, for example a pulley system to serve as a conveyor whereby for example harvested fruit or other crops may be transported along the length of the poly tunnel, thereby assisting in the harvesting operation as the person or machinery used in harvesting the crop need not make repeated trips along the length of the poly tunnel in order to remove harvested product from the tunnel but rather the harvested product may be placed upon the conveyor and automatically be transported to the end of the poly tunnel. In addition, the drive shaft 30 may be arranged to drive auxiliary drive shafts 36 which extend along the uprights 20. Power take off points 38 may be provided whereby other devices may be powered. By way of example only, these may comprise devices for use in the automatic opening and closing of vents or screens or for use in the opening or closing of doors.

Although driven by a common motor, separate clutches and gearing mechanisms may be provided to allow several devices to be controlled independently.

FIG. 10 is a diagrammatic view of an alternative end frame design comprising a pair of triangular frames 50 interconnected by a cross member 52. Each triangular frame 50 includes an upright 54, a base member 56 and a diagonal strut 58. FIG. 11 illustrates a connector 60 which may be used to connect the upright 54, diagonal strut 58 and cross member 52 to one another, the connector 60 including a sleeve 62 which can be clamped around the upright 54 and having brackets 64, 66 secured thereto which are securable to the cross member 52 and diagonal strut 58.

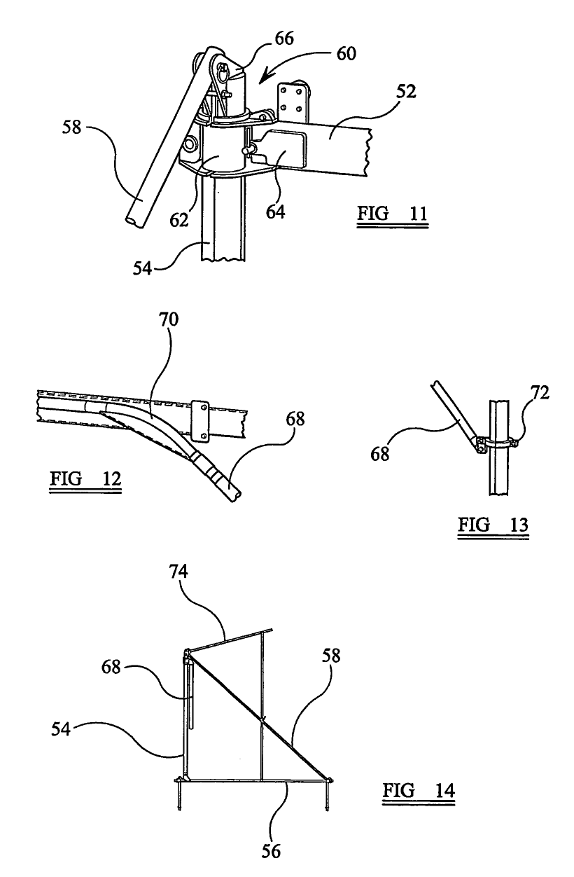

An end one of the hoops of the poly tunnel is replaced by a pair of telescopic bracing struts 68 connected between brackets 70 secured to the cross member 52 (see FIG. 12) and brackets 72 secured to the uprights 54 (see FIG. 13). A further bracing strut 74 may also be provided between the cross member 52 and the next hoop of the poly tunnel (see FIG. 14).

It will be appreciated that a number of changes may be made to the specific arrangements described hereinbefore and the application is not limited to the specific arrangements disclosed. By way of example only, it will be appreciated that a number of dimensional changes could be made and the nature of the various connections could be changed. Further, the position of the motor may be changed.

Although the description hereinbefore is of a poly tunnel it will be appreciated that the support system of the invention may be used in other applications. For example, the support system may be used in supporting agricultural crops. One suitable application would be in the support of a table grape system.

1. A support system including an end frame comprising a pair of uprights and a cross member, each upright being secured at its lower end to a base member which extends, in use, in a direction generally transverse to the axis of the cross member, and a diagonal strut interconnecting the base member and associated upright.

2. A system according to claim 1, further comprising a hoop support leg connected between the base member and the diagonal strut.

3. A system according to claim 1, further comprising a hoop support leg secured to the upright.

4. A system according to claim 1, further comprising a bracing strut secured between the upright and the cross member.

5. A system according to claim 1, further comprising an adjustable bracket connecting the diagonal strut, upright and cross member to one another.

6. A system according to claim 1, further comprising a drive shaft extending adjacent at least part of the cross member.

7. A system according to claim 6, further comprising a second end frame, the drive shaft being connected to a drive shaft associated with the second end frame.

8. A poly tunnel comprising a support system according to claim 1 and a cover supported by the support system.

9. A support system arrangement comprising a plurality of support systems which are located side-by-side one another, a drive shaft being associated with each support system, the drive shafts being interconnected such that a single motor can be used to drive all of the drive shafts each support system including an end frame comprising a pair of uprights and a cross member, each upright being secured at its lower end to a base member which extends, in use, in a direction generally transverse to the axis of the cross member, and a diagonal strut interconnecting the base member and associated upright.

10. (canceled)
